(19) United States
(12) Patent Application Publication
(10) Pub. No.: US 2002/0021935 A1
(43) Pub. Date: Feb. 21, 2002

(54) Anchoring structure for folding keyboards

(75) Inventor: Chin-Cheng Li, Hsin Chuang City (TW)

Correspondence Address: DOUGHERTY & TROXELL, SUITE 1404, 5205 LEESBURG PIKE, Falls Church, VA, 22041, US

(73) Assignee: Darfon Electronics Corp.

(21) Appl. No.: 09/925,330

(22) Filed: Aug. 10, 2001

(30) Foreign Application Priority Data
Aug. 15, 2000 (TW) 89214153

(51) Int. Cl. F16D 1/12; F16D 3/00; F16C 11/00

(52) U.S. Cl. 403/119

(57) ABSTRACT

An anchoring structure for a folding keyboard includes a first base, a second base and a linkage means. The first base has an upper surface which has a first key zone located thereon and an inner edge which has a first pivot joint located thereon. The second base has an upper surface which has a second key zone located thereon and an inner edge which has a second pivot joint located thereon. The first and second pivot joint engage respectively and pivotally with two edges of a linkage means so that the first and second bases and the linkage means may be folded and extended. The first and second bases have respectively a lower surface which has a slide channel located thereon and corresponding to each other to form a sliding path when the keyboard is extended. A slide block is located in one of the slide channel and movable reciprocally on the slide path. When the slide block is moved to the middle position between the two bases, it produces a constraint effect on the keyboard and allows the keyboard to be extended on a flat surface.

### FIELD OF THE INVENTION

This invention relates to an anchoring structure for folding keyboards and particularly an anchoring structure for extending a folding keyboard and maintaining the keyboard on a flat surface.

### BACKGROUND OF THE INVENTION

With the arriving of the information age, people have increasing dependence on data processing devices. The commonly used data processing devices include personal computers (PC), Notebook computers, Handheld computers (Palm), Personal Digital Assistants (PDA) and Mobile Phones and the like. In general, a data processing device includes a processor, a display device and a keyboard. The processor mainly is used to perform data processing. The function of the display device is to display the results of data processing, and the keyboard is for entering commands to instruct the processor to perform data processing jobs desired.

Because of technology innovation and progress, nowadays the processors and display devices can be made light and compact. However, the keyboards still cannot be shrunk due their utilization and operations have to take into account of the ergonomic factors. Too small of the keyboards will make operation difficult. Whereas, not to shrink the keyboard to a smaller size will make carrying of the keyboard inconvenient. An alternative is to make the keyboard foldable so that the keyboard may be folded and stacked when not in use thereby makes carrying more convenient for users.

Referring to FIGS. 1A and 1B for a conventional folding keyboard, the keyboard 10 has a plurality of keys marked by different notations, including numeral keys, function keys and notation keys. Users may input data through these keys to the processor to perform data processing. In order to attain the folding function, the keyboard 10 adapted the conventional techniques consists of four bases, including a first outer base 11, a first inner base 12, a second outer base 13, and a second inner base 14. The upper surfaces of the aforesaid bases have respectively a key zone 110, 120, 130 and 140. The first outer base 11 and the first inner base 12 are pivotally engaged with two edges of a first linkage means 15. The second outer base 13 and the second inner base 14 are pivotally engaged with two edges of a second linkage means 16. The first inner base 12 and the second inner base 14 are pivotally engaged with a hinge 17.

The first outer key zone 110 and the first inner key zone 120 do not juxtapose with each other when the keyboard 10 is unfolded and extended, hence the first outer key zone 110 must be pushed toward the first inner key zone 120 to make them adjacent with each other. Similarly, the second outer key zone 130 and the second inner key zone 140 do not juxtapose with each other when the keyboard is extended, hence the second outer key zone 130 must be pushed toward the second inner key zone 140 to make them juxtaposed and adjacent with each other. Then the keyboard 10 may be used in the fully extended state.

When to fold the keyboard 10, use the turning mechanisms of the first and second linkage means 15 and 16, and the hinge 17 to stack the lower surface of the first inner base 12 upon the lower surface of the second inner base 14, and to stack the upper surface of the first outer base 11 upon the upper surface of the first inner base 12, and to stack the upper surface of the second outer base 13 upon the upper surface of the second inner base 14. The width of the first linkage means 15 is about equal to the combined stacking thickness of the first inner base 12 and the first outer base 11, and the width of the second linkage means 16 is about equal to the combined stacking thickness of the second inner base 14 and the second outer base 13. Hence the folded keyboard 10 has a surface size about a quarter of the extended surface thereof (as shown in FIG. 1C).

Whereas, the bases 11, 12, 13 and 14 of the conventional folding keyboard 10 may turn freely about the linkage means 15, 16 and the hinge 17 without support. When the keyboard 10 is placed on a flat table top for use, the bases 11, 12, 13 and 14 of the keyboard 10 will be supported and constrained by the table top, and the bases 11, 12, 13 and 14 cannot turn about the linkage means 15, 16 and the hinge 17. As the bases 11, 12, 13 and 14 are maintained on the tabletop, there is no operational problem. However when to move the keyboard 10 around, or users habitually place the keyboard 10 on their lap when in use, the bases 11, 12, 13 and 14 will be wobbling because of no anchoring means to support them firmly, and the bases 11, 12, 13 and 14 will turn about the linkage means 15, 16 and the hinge 17. As a result, the bases cannot be maintained substantially horizontal. It becomes a great annoyance to users (as shown in FIG. 1D).

### SUMMARY OF THE INVENTION

In view of the foregoing disadvantages, it is therefore an object of the invention to provide an anchoring structure for folding keyboard that is capable of constraining two adjacent bases so that the bases may be maintained on the same horizontal surface, thereby to solve the keyboard operation problems that might otherwise incur.

The folding keyboard according to the present invention consists of a first base, a second base and a linkage means. The upper surfaces of the first base and second base have respectively a key zone. The first base has an inner edge which has at least one pivot joint located at a selected position. The second base has an inner edge which has a second pivot joint corresponding to the first pivot joint of the first base. The linkage means has two edges engaged respectively and pivotally with the first and second pivot joint such that the first and second bases may be folded and extended through the linkage means.

In one aspect of the invention, the first and second bases have respectively a lower surface each has a slide channel formed thereon. The locations of the slide channels are corresponding to each other. When the keyboard is unfolded and extended on a flat surface, the slide channels on the two bases will form a continuous sliding path. The anchor structure may be moved reciprocally on the sliding path. When the anchor structure is moved to a middle position between the two bases, it will produce a constraint effect to the keyboard and prevent the first and second bases from turning about the linkage means, thereby the folding keyboard may be maintained at the extended state. When the anchor structure is moved inside the sliding channel at either base, it does not have constraint effect to the keyboard, and the keyboard may be folded and stacked to a smaller size to facilitate carrying.

As the folding keyboard of the invention has an anchoring structure which may provide a constraint effect when the keyboard is extended, the keyboard may be maintained on the same flat surface when in use even without the support of a table top. Thus the keyboard may be moved freely and operated more conveniently. The anchoring structure may also release the constraint from the folded keyboard so that the keyboard may become smaller size to facilitate carrying and storing.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are schematic views of a folding keyboard adapting conventional techniques.

FIG. 1C is a schematic view of a folding keyboard adapting conventional techniques, after folded.

FIG. 1D is a schematic view of a folding keyboard adapting conventional techniques, extended without support.

FIG. 2A is a top view of a first embodiment of the present invention.

FIGS. 2B and 2C are schematic views of the anchoring structure in motion, according to the first embodiment.

FIG. 3A is a top view of a second embodiment of the present invention.

FIGS. 3B and 3C are schematic views of the anchoring structure of the second embodiment.

FIGS. 3D and 3E are other schematic views of the anchoring structure of the second embodiment.

FIGS. 4A and 4B are further schematic views of the anchoring structure of the second embodiment.

### DESCRIPTION OF THE PREFERRED EMBODIMENTS

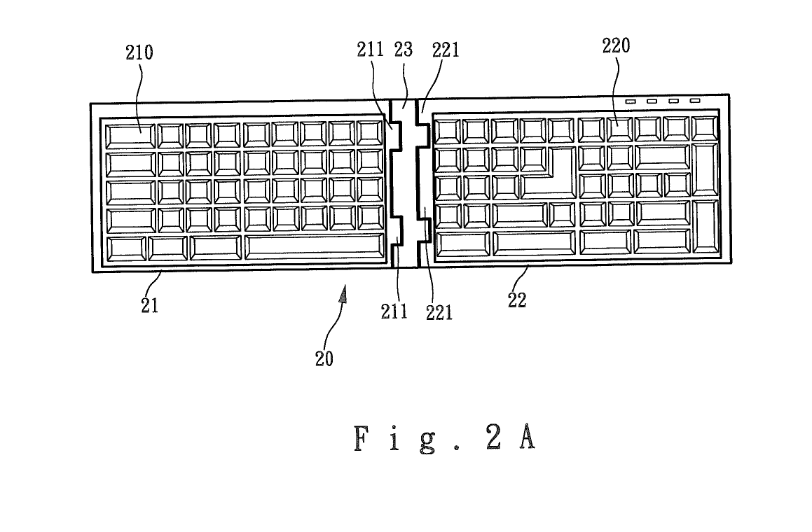

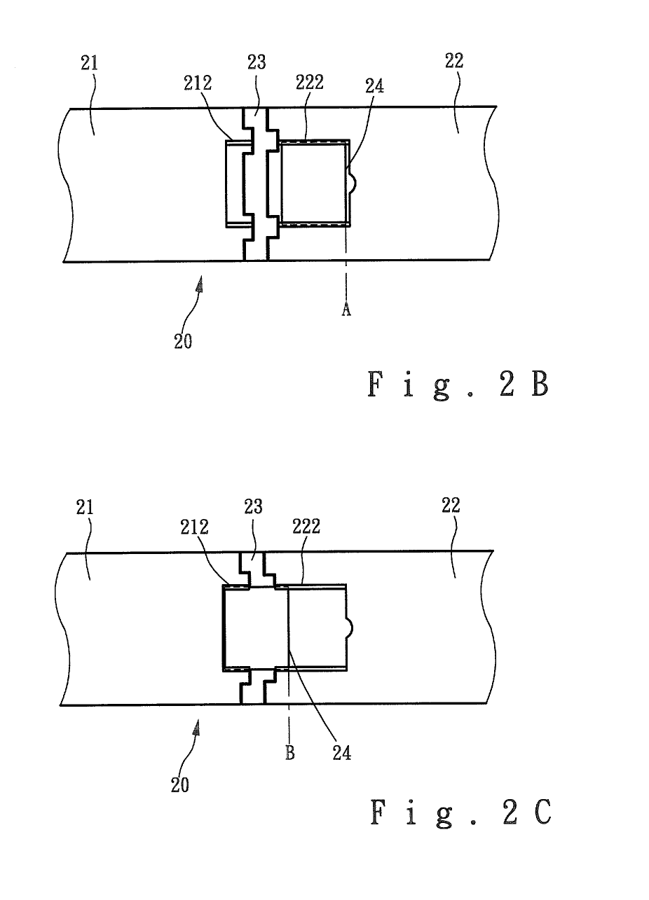

Referring to FIG. 2A for a first embodiment of the invention, the folding keyboard 20 is a two-way type folding keyboard and may be folded in half to make the surface area of the keyboard after folding and stacking becomes one half of the original size. The folding keyboard 20 consists of a first base 21, a second base 22 and a linkage means 23.

The first and second base 21 and 22 have respectively an upper surface which has a first key zone 210 and a second key zone 220. The second key zone 220 (first key zone 210) is movable to juxtapose with the first key zone 210 (second key zone 220) to form a completed keyboard. The first base 21 has an inner edge which has at least one first pivot joint 211 located at a selected position thereof. The second base 22 has an inner edge which has a second pivot joint 221. The linkage means 23 has two edges engaged respectively and pivotally with the first pivot joint 211 and the second pivot joint 221 so that the first and second bases 21 and 22 may be folded and extended through the linkage means 23.

Referring to FIGS. 2B and 2C, the first and second bases 21 and 22 have respectively a lower surface which have a slide channel 212 and 222 located thereon. The slide channels 212 and 222 are corresponding to each other. When the keyboard 20 is extended, the slide channels 212 and 222 of the first and second bases 21 and 22 will form a sliding path to allow a slide block 24 moving reciprocally on the sliding path between a first position A and a second position B. The slide block 24 is a plate element. When the slide block 24 is moved to the second position B, the slide block 24 is straddled over the two bases 21 and 22, and constrains the two bases 21 and 22 like a latch. Hence the first and second bases 21 and 22 cannot turn about the linkage means 23. Thereby the folding keyboard 20 can be extended and maintained on the same flat surface. When the slide block 24 is moved to the first position A, the slide block 24 is located at the slide channel 222 of the second base board 22. In this occasion, the slide block 24 does not have constraint effect on the keyboard 20, and the first and second bases 21 and 22 may turn freely about the linkage means 23. The keyboard 20 then may be folded in half to reduce the keyboard area to one half of its original size to facilitate carrying.

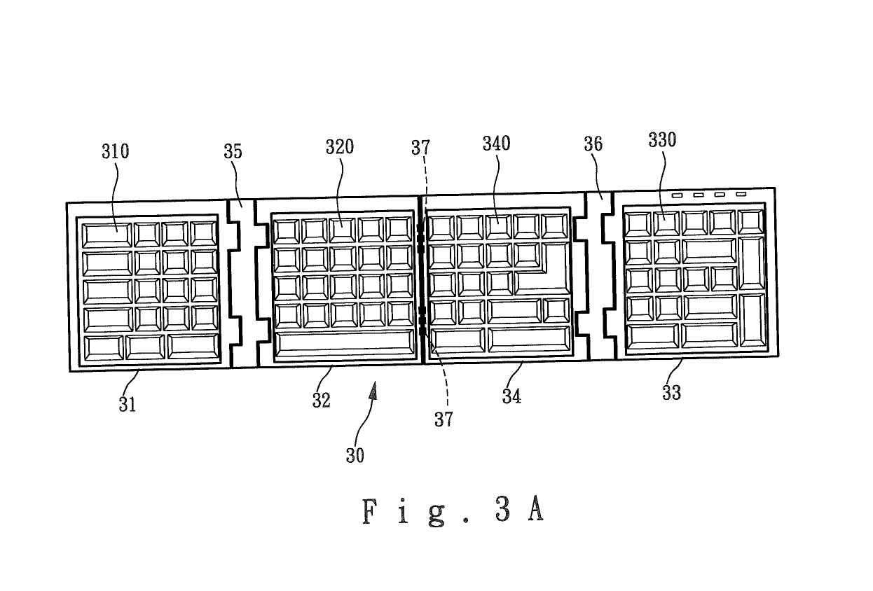

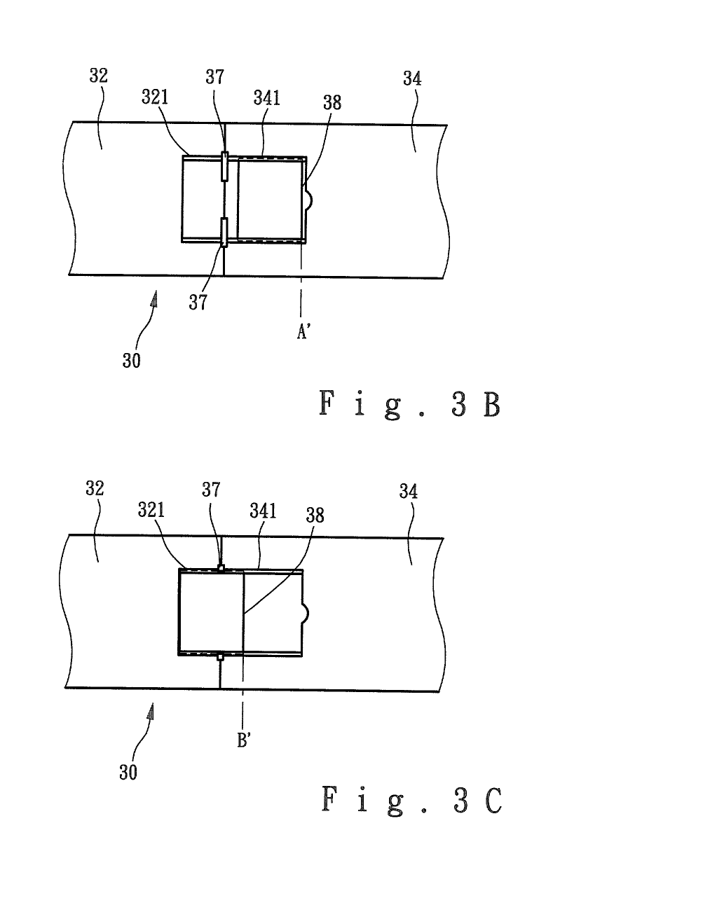

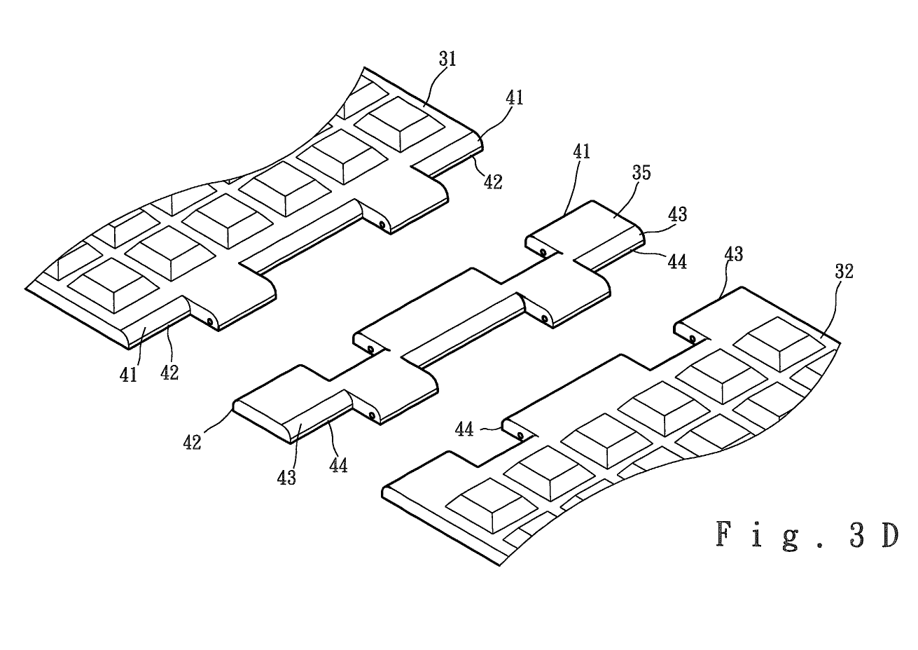

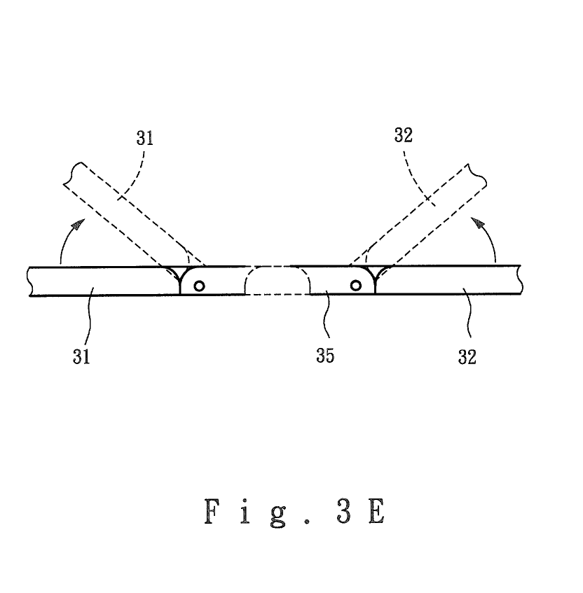

Referring to FIG. 3A for a second embodiment of the invention, the folding keyboard 30 is a four- way type folding keyboard and may make the surface of the keyboard after folding and stacking becomes a quarter of the original size. The folding keyboard 30 consists of a first outer base 31, a first inner base 32, a second outer base 33, and a second inner base 34.

The foregoing four bases 31, 32, 33 and 34 have respectively an upper surface for forming key zones 310, 320, 330 and 340 thereon. The first outer base 31 and first inner base 32 are pivotally engaged with two edges of a first linkage means 35. The second outer base 33 and second inner base 34 are pivotally engaged with two edges of a second linkage means 36. The first inner base 32 and second inner base 34 are pivotally engaged with two edges of a hinge 37. The first outer base 31 and first inner base 32 are turnable about the first linkage means 35 to allow the two bases 31 and 32 to proceed extending and folding movements. The second outer base 33 and second inner base 34 are turnable about the second linkage means 36 to allow the two bases 33 and 34 to proceed extending and folding movements. The first inner base 32 and second inner base 34 are turnable about the hinge 37 to allow the two bases 32 and 34 to proceed extending and folding movements.

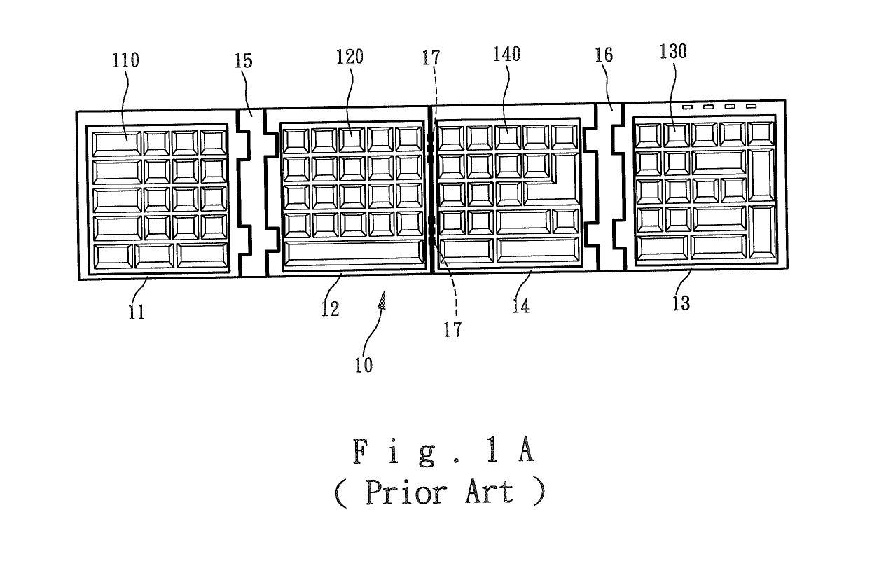

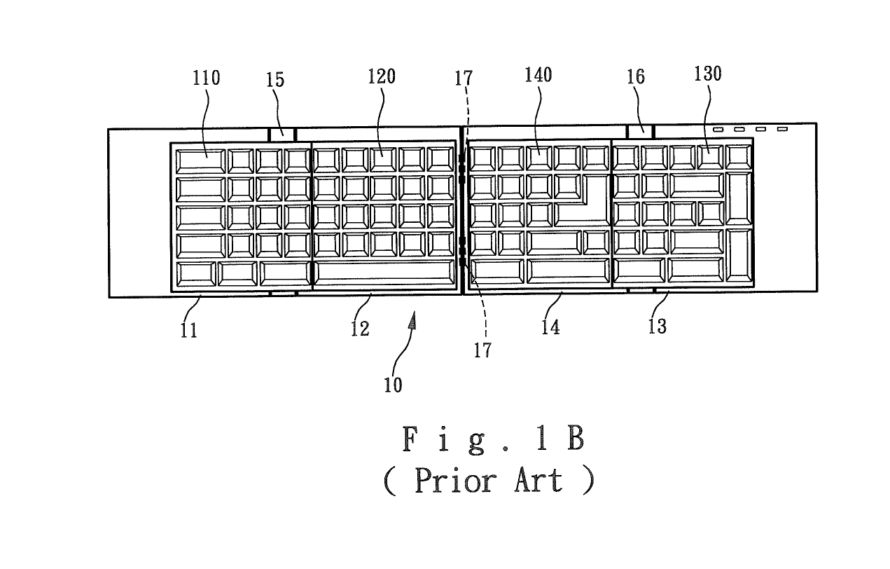

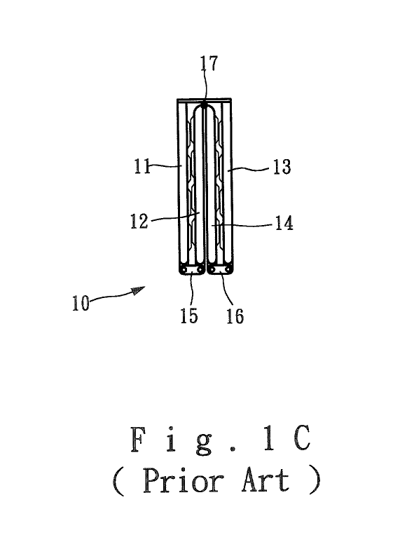

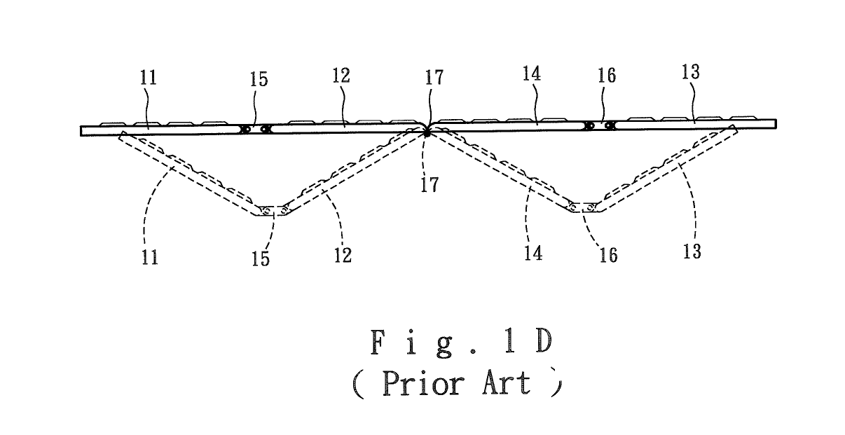

To fold the keyboard 30, firstly, stack the lower surface of the first inner base 32 upon the lower surface of the second inner base 34, and in the meantime stack the upper surface of the first outer base 31 upon the upper surface of the first inner base 32, and stack the upper surface of the second outer base 33 upon the upper surface of the second inner base 34. The resulting folded keyboard surface becomes a quarter of the original size, and is substantially same as the one achieved by using conventional techniques (shown in FIG. 1C). When the keyboard 30 is extended, the four bases 31, 32, 33 and 34 are unfolded on a flat surface. In order to maintain the bases 31, 32, 33 and 34 of the extended keyboard 30 on the same flat surface when moving or held on the lap of an user, the keyboard 30 must provide every two adjacent bases an anchoring structure to prevent the bases from sagging by gravity.

Referring to FIGS. 3B and 3C, in the second embodiment, the first and second inner bases 32, 34 have respectively a lower surface which has a slide channel 321 and 341 located thereon. The slide channels 321 and 341 are corresponding to each other. Hence when the keyboard 30 is extended on a flat surface, the slide channels 321 and 341 of the first and second inner bases 32 and 34 will form a sliding path to allow a slide block 38 moving reciprocally on the sliding path between a first position A′ and a second position B′. When the slide block 38 is moved to the second position B′, the slide block 38 is straddled over the two inner bases 32 and 34, and constrains the two inner bases 32 and 34 like a latch. Hence the first and second inner bases 32 and 34 cannot turn about the hinge 37. Thereby the first and second inner bases 32 and 34 may be maintained at the extended state. When the slide block 38 is moved to the first position A′, the slide block 38 is located in the slide channel 341 of the second inner base 34. In this occasion, the slide block 38 does not have constraint effect on the first and second inner bases 32 and 34, and the first and second inner bases 32 and 34 may turn about the hinge 37.

As to the anchoring method, after the first outer base 31 and first inner base 32 having been extended, and for the second outer base 33 and second inner base 34 having been extended, one way is, during the keyboard 30 is extending, to move the first key zone 310 to juxtapose with the first inner key zone 320 to make the first key zone 310 forming a constraint effect on the first outer base 31 and first inner base 32 to prevent the first outer base 31 and first inner base 32 from turning about the first linkage means 35. However such a constraint way is a conventional technique and does not produce desirable results for the commonly used folding keyboards. Moreover, when the keyboard 30 does not have support, the first outer base 31 and second outer base 33 tend to sag easily. To remedy this problem, the present invention provides a constraint method for the first outer base 31 and first inner base 32, and also for the second outer base 33 and second inner base 34. Details will be elaborated as follows.

Referring to FIGS. 3D and 3E, in order to prevent the first outer base 31 from sagging by gravity when the folding keyboard 30 is extended and cause operation inconvenience to users, the adjacent edges of the first outer base 31 and the first linkage means 35 have respectively a curved surface 41 formed at an upper section thereof, and the lower section of the edges forms a vertical surface 42. Similarly, the adjacent edges of the first inner base 32 and the first linkage means 35 have respectively an upper curved surface 43 and a lower vertical surface 44.

The purpose of forming the curved and vertical surface on the edges is that, when the upper surfaces of the first outer base 31 and the first inner base 32 are stacking together, the adjacent edges of the first outer base 31 and the first linkage means 35 may turn smoothly relative to each other without interference because of the curved surfaces 41. Similarly, the upper curved surfaces 43 allow the first inner base 32 and the adjacent first linkage means 35 to turn smoothly relative to each other without interference so that the first outer base 31 and first inner base 32 may be folded and stacked together smoothly. Furthermore, when the first outer base 31 and first inner base 32 are extending to form a plane surface, the lower vertical surface 42 on the adjacent edges of the first outer base 31 and the first linkage means 35 will contact each other without overextending beyond the plane surface. Similarly, the lower vertical surface 44 on the adjacent edges of the first inner base 32 and the first linkage means 35 will contact each other without overextending beyond the plane surface. Hence the first outer base 31, the first linkage means 35 and the first inner base 32 will be extended on the same flat surface without causing the first outer base 31 sagging downwards because of gravity force.

The construction of the second outer base 33 and second inner base 34 are substantially same as the one shown in FIGS. 3D and 3E. Their purpose is to prevent the second outer base 33 from sagging under no bottom support circumstances when the keyboard 30 is extended. The principle and operation is same as above. Details will be omitted here.

It is to be noted that the width of the first linkage means 35 is equal to the combined thickness after the first outer base 31 is stacked upon the first inner base 32. By the same token, the width of the second linkage means 36 is equal to the combined thickness after the second outer base 33 is stacked upon the second inner base 34. Thereby, there will be no interference occurred between the bases during the folding processes.

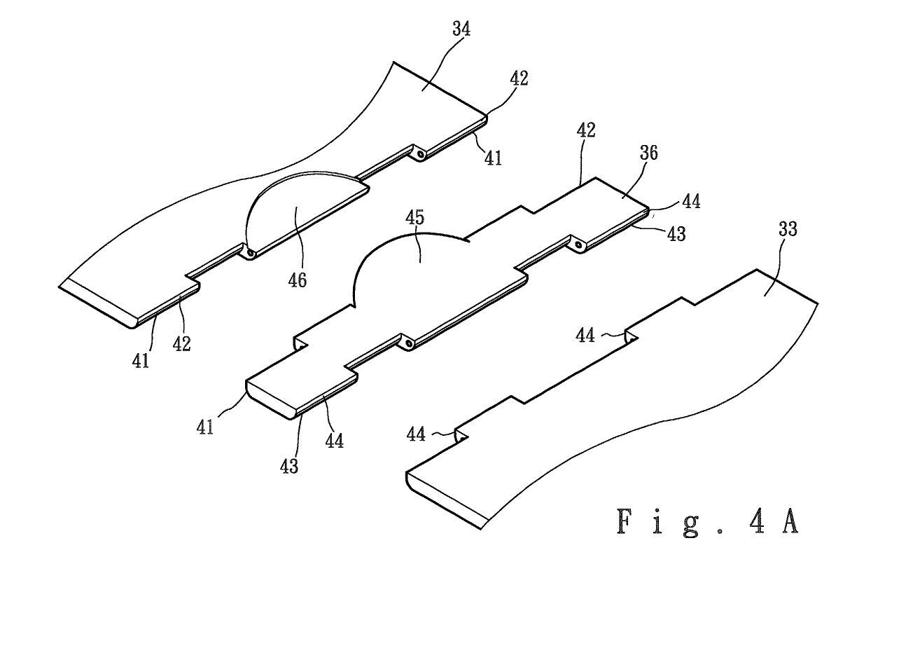

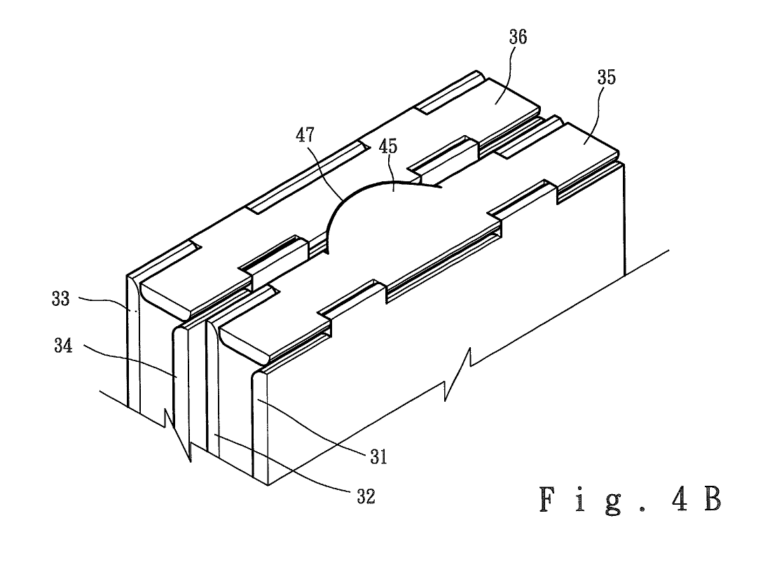

Referring to FIGS. 4A and 4B, the second linkage means 36 has a protrusive curved support flange 45 extended outward from the bottom side of the adjacent edge of the second inner base 34. The support flange 45 may support the lower surface of the second inner base 34 when the keyboard 30 is extended so that the second linkage means 36 and second outer base 33 will be prevented from sagging under gravity force. In order to make the lower surface of the second inner base 34 matching the support flange 45 when extended, there is an indented recess 46 formed on the lower surface of the first inner base 32. The indented recess 46 has a shape and depth matching the support flange 45 to prevent interference between the second linkage means 36 and second inner base 34 during extending and to make the keyboard 30 maintaining on the same flat surface. Similarly, when the keyboard 30 is folding, in order to make the first linkage means 35 juxtaposing with the second linkage means 36, the lower surface of the first linkage means 35 has an indent recess 47 to match the support flange 45. The indent recess 47 also a shape and depth matching the support flange 45 for holding the support flange 45 during the keyboard folding to prevent interference or misalignment between the first linkage means 35 and second linkage means 36.

Furthermore, the support flange 45 may be located at the lower side of the first linkage means 35 adjacent the first inner base 32. The lower surface of the first base inner base 32 has an indented recess matching the support flange 45. The operation principle is same as the one set forth above, thus will be omitted here.

While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An anchoring structure for a folding keyboard which includes a first base having an upper surface with a first key zone located thereon and an inner edge having at least a first pivot joint located at a selected position, a second base having an upper surface with a second key zone located thereon and an inner edge having a second pivot joint located thereon, and a linkage means having two edges pivotally engaged with the first and the second pivot joint to allow the first and second bases to fold and extend through the linkage means, the anchoring structure comprising:
at least one first slide channel located on a lower surface of the first base;
at least one second slide channel located on a lower surface of the second base at a position corresponding to the first slide channel such that the first and second slide channel forming a sliding path when the folding keyboard is extended; and
at least one slide block located in one of the slide channel movable reciprocally on the sliding path when the folding keyboard is extended and producing a constraint effect on the keyboard to maintain the keyboard at the extended state when the slide block is moved to a middle position between the two bases.

2. The anchoring structure of claim 1, wherein the anchoring structure releases the constraint effect on the keyboard when the slide block is moved to one of the slide channels such that the first and the second base board are turnable about the linkage means for folding.

3. The anchoring structure of claim 1, wherein one of the first key zone and the second key zone are movable to juxtapose with each other for forming a completed keyboard.

4. An anchoring structure for a folding keyboard which includes a first outer base, a first inner base, a second outer base and a second inner base, the first outer base and the first inner base being respectively and pivotally engaged with two edges of a first linkage means, the second outer base and the second inner base being respectively and pivotally engaged with two edges of a second linkage means, the first inner base and the second inner base being respectively and pivotally engaged with a hinge such that the bases are turnable through the linkage means and the hinge to allow the keyboard folding and extending, the anchoring structure comprising:
at least one first slide channel located on a lower surface of the first inner base;
at least one second slide channel located on a lower surface of the second inner base at a position corresponding to the first slide channel such that the first and second slide channel forming a sliding path when the folding keyboard is extended; and
at least one slide block located in the slide channel movable reciprocally on the sliding path when the folding keyboard is extended, and producing a constraint effect on the keyboard to maintain the keyboard at the extended state when the slide block is moved to a middle position between the two inner bases.

5. The anchoring structure of claim 4, wherein the first outer base has an upper surface with a first outer key zone located thereon, the first inner base having an upper surface with a first inner key zone located thereon, the second outer base having an upper surface with a second outer key zone located thereon, the second inner base having an upper surface with a second inner key zone located thereon,
wherein when the keyboard is extended, the first outer key zone is moved to the first inner key zone for juxtaposing therewith, and the second outer key zone is moved to the second inner key zone for juxtaposing therewith to form a completed keyboard.

6. An anchoring structure for a folding keyboard comprising a first outer base, a first inner base, and a first linkage means which has two edges respectively and pivotally engaged with the first outer base and the first inner base for the two bases to extend and fold, the improvement comprising:
the first outer base and the first linkage means have respectively an edge adjacent each other, the edge having a vertical surface at a lower section thereof so that when the first outer base and the first linkage means are extended, the first outer base and the first linkage means contact each other and maintaining on a same flat surface.

7. The anchoring structure of claim 6, wherein the first outer base and the first linkage means have respectively a curved surface formed at an upper section of the adjacent edges to allow the first outer base and the first linkage means folding and extending through the curved surface.

8. The anchoring structure of claim 6, wherein the first inner base and the first linkage means have respectively a vertical surface at a lower section of the adjacent edges so that when the first inner base and the first outer base are extended, the vertical lower surfaces allow the first inner base, the first outer base and the first linkage means contact with one another and maintaining on the same flat surface.

9. The anchoring structure of claim 8, wherein the first inner base and the first linkage means have respectively a curved surface formed at an upper side of the adjacent edge to allow the first inner base and the first linkage means folding and extending through the curved surface.

10. The anchoring structure of claim 8, wherein the first linkage means has a support flange located at an edge of a lower side thereof, when the keyboard is extended, the support flange supports a lower surface of the first inner base to prevent the first outer base and the first linkage means from sagging due to gravity force.

11. The anchoring structure of claim 10, wherein the first inner base has an indented recess corresponding to the support flange for housing the support flange when the keyboard is extended to avoid interference.

12. The anchoring structure of claim 1 1, wherein the folding keyboard further includes a second inner base and a second outer base to engage respectively and pivotally with two edges of a second linkage means, the first inner base and the second inner base being pivotally engaged with a hinge, the second inner base and the second outer base having respectively a vertical surface formed at a lower section of the adjacent edges with the second linkage means to allow the second inner base and second outer base contact each other when extended and maintaining on the same flat surface.

13. The anchoring structure of claim 12, wherein the second linkage means has an indented recess corresponding to the support flange for housing the support flange when the keyboard is folding to avoid interference.

14. The anchoring structure of claim 12, wherein the folding keyboard further includes at least one first slide channel located on a lower surface of the first inner base, at least one second slide channel located on a lower surface of the second inner base, and at least one slide block located in one of the slide channels; the two slide channels being corresponding to each other and forming a sliding path when the folding keyboard is extended, the slide block being movable reciprocally on the sliding path when the folding keyboard is extended, and producing a constraint effect on the two inner bases to maintain the inner bases at the extended state when the slide block is moved to a middle position between the two inner bases.

15. The anchoring structure of claim 12, wherein the second inner base and the second outer base have respectively a curved surface formed at an upper section of an edge adjacent the second linkage means for the second inner base and the second outer base to fold and extend through the curved surface.
